(19) United States
(12) Patent Application Publication
(10) Pub. No.: US 2024/0362697 A1
(43) Pub. Date: Oct. 31, 2024

(54) GENERATION OF VEHICLE SUGGESTIONS BASED UPON DRIVER DATA

(71) Applicant: State Farm Mutual Automobile Insurance Company, Bloomington, IL (US)

(72) Inventors: Aaron Williams, Congerville, IL (US); Scott T. Christensen, Salem, OR (US); Joseph P. Harr, Bloomington, IL (US); Ryan M. Gross, Normal, IL (US)

(21) Appl. No.: 18/597,450

(22) Filed: Mar. 6, 2024

Related U.S. Application Data
(60) Provisional application No. 63/624,616, filed on Jan. 24, 2024.
(60) Provisional application No. 63/528,141, filed on Jul. 21, 2023.
(60) Provisional application No. 63/462,101, filed on Apr. 26, 2023.

(51) Int. Cl. G06Q 30/0601; G06Q 30/0283

(52) U.S. Cl. CPC G06Q 30/0631; G06Q 30/0283

(57) ABSTRACT

A computer-implemented method for providing vehicle suggestions to a buyer, the method including, by one or more processors (i) detecting a signal that the buyer is interested in purchasing a vehicle; (ii) obtaining driver data associated with a driver; (iii) inputting the driver data associated with the driver into a generative artificial intelligence (AI) model to generate vehicle suggestions for the driver, wherein the generative AI model is trained on vehicle data to identify vehicle traits and is configured to (a) associate vehicle traits with different vehicles, (b) associate driver data with vehicle traits, (c) analyze data associated with the driver to identify vehicle traits associated with a driver, (d) determine, based upon the desired vehicle traits associated with the driver, vehicle suggestions, and/or (e) generate an output including vehicle suggestions for the driver; and/or (iv) presenting the vehicle suggestions to the buyer.

### CROSS-REFERENCE TO RELATED APPLICATIONS

This application claims priority to and the benefit of the filing date of (1) provisional U.S. Patent Application No. 63/462,101 entitled “GENERATION OF VEHICLE SUGGESTIONS BASED ON DRIVER DATA,” filed on Apr. 26, 2023, (2) provisional U.S. Patent Application No. 63/528,141 entitled “GENERATION OF VEHICLE SUGGESTIONS BASED UPON DRIVER DATA,” filed on Jul. 21, 2023, and (3) provisional U.S. Patent Application No. 63/624,616 entitled “SYSTEMS AND METHODS FOR NEGOTIATING THE PURCHASE OF A VEHICLE USING A CHATBOT,” filed on Jan. 24, 2024. The entire contents of each of the above-identified applications is hereby expressly incorporated herein by reference.

### FIELD OF THE INVENTION

The present disclosure generally relates to the generation of vehicle suggestions based upon driver data and more particularly, generation of vehicle suggestions based upon driver data using a generative artificial intelligence (AI) model such as an AI or machine learning (ML) chatbot and/or voice bot.

### BACKGROUND

People may want to purchase a vehicle for a variety of reasons. For example, a driver may want to buy a new vehicle because his/her current vehicle no longer suits his/her needs or because his/her current vehicle is too difficult or expensive to maintain. However, with the wide variety of vehicles on the market, a driver may face difficulties in determining which vehicle best suits his/her needs. Therefore, a tool for providing vehicle suggestions to a buyer may be useful.

The conventional techniques for generating vehicle suggestions may include additional ineffectiveness, inefficiencies, encumbrances, and/or other drawbacks.

### SUMMARY

The present embodiments may relate to, inter alia, systems and methods for generating vehicle suggestions based upon driver data using a generative AI model (e.g., an AI or ML chatbot and/or voice bot).

In one aspect, a computer-implemented method for providing vehicle suggestions to a buyer may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. In one instance, the computer-implemented method may include (1) detecting, by one or more processors, a signal that the buyer is interested in purchasing a vehicle; (2) obtaining, by the one or more processors, driver data associated with a driver; (3) inputting, by the one or more processors, the driver data associated with the driver into a generative artificial intelligence (AI) model to generate vehicle suggestions for the driver, wherein the generative AI model is trained on vehicle data to identify vehicle traits and is configured to (i) associate vehicle traits with different vehicles, (ii) associate driver data with vehicle traits, (iii) analyze data associated with the driver to identify vehicle traits associated with a driver, (iv) determine, based upon the desired vehicle traits associated with the driver, vehicle suggestions, and/or (v) generate an output including vehicle suggestions for the driver; and/or (4) presenting, by the one or more processors, the vehicle suggestions to the buyer (such as displaying text, textual, visual, or graphical output and/or vehicle suggestions on a display, screen or other medium, and/or presenting verbal or audible output and/or vehicle suggestions via a voice bot, chatbot, or other means). The method may include additional, less, or alternate functionality or actions, including those discussed elsewhere herein.

In another aspect, a computer system for providing vehicle suggestions to a buyer may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to: (1) detect that a buyer is interested in buying a vehicle; (2) obtain driver data associated with a driver; (3) input the driver data associated with the driver to a generative AI model to generate vehicle suggestions for the buyer, wherein the generative AI model is trained on vehicle data to identify vehicle traits and is configured to (i) associate vehicle traits with different vehicles, (ii) analyze data associated with the driver to identify vehicle traits associated with a driver, (iii) determine, based upon the desired vehicle traits associated with the driver, vehicle suggestions, and/or (iv) generate an output including vehicle suggestions for the driver; and/or (4) present the vehicle suggestions to the buyer (such as displaying text, textual, visual, or graphical output and/or vehicle suggestions on a display, screen or other medium, and/or presenting verbal or audible output and/or vehicle suggestions via a voice bot, chatbot, or other means). The computer system may include additional, less, or alternate functionality, including that discussed elsewhere herein.

In another aspect, a non-transitory computer-readable medium storing processor-executable instructions for providing vehicle suggestions to a buyer that, when executed by one or more processors, cause the one or more processors to: (1) detect a signal that a buyer is interested in purchasing a vehicle; (2) obtain driver data associated with a driver; (3) input the driver data associated with the driver to a generative AI model to generate vehicle suggestions for the buyer, wherein the generative AI model is trained on vehicle data to identify vehicle traits and is configured to (i) associate vehicle traits with different vehicles, (ii) analyze data associated with the driver to identify vehicle traits associated with a driver, (iii) determine, based upon the desired vehicle traits associated with the driver, vehicle suggestions, and/or (iv) generate an output including vehicle suggestions for the buyer; and/or (4) present the vehicle suggestions to the buyer (such as displaying text, textual, visual, or graphical output and/or vehicle suggestions on a display, screen or other medium, and/or presenting verbal or audible output and/or vehicle suggestions via a voice bot, chatbot, or other means). The instructions may direct additional, less, or alternate functionality, including that discussed elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computing environment in which methods and systems for generating vehicle suggestions based upon driver data are implemented, according to one embodiment.

FIG. 2 depicts a combined block and logic diagram in which exemplary computer-implemented methods and systems for training an ML chatbot are implemented, according to one embodiment.

FIG. 3 depicts a combined block and logic diagram in which exemplary computer-implemented methods and systems for using ML to generate vehicle suggestions based upon driver data are implemented, according to one embodiment.

FIGS. 4A-4C depict exemplary displays of an application employing a chatbot.

FIG. 5 depicts a diagram of an exemplary computer system for negotiation for the purchase of a vehicle.

FIG. 6 depicts a flow diagram of an exemplary computer-implemented method for generating vehicle suggestions based upon driver data, according to one embodiment.

FIG. 7 depicts a flow diagram of an exemplary computer-implemented method for negotiating purchase of a vehicle, according to one embodiment.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, methods and systems for generating vehicle suggestions based upon driver data using generative AI including AI or ML chatbots and/or voice bots.

In some embodiments, one or more processors may detect a signal that a buyer is interested in purchasing a vehicle. The one or more processors may obtain driver data associated with a driver and input the driver data into a generative AI model. The AI model may generate an output of vehicle suggestions to the buyer. In some embodiments, generative AI models (also referred to as generative ML models) including voice bots and/or chatbots may be configured to utilize artificial intelligence and/or ML techniques. In certain embodiments, a voice or chatbot may be a ChatGPT chatbot. The voice or chatbot may employ supervised or unsupervised ML techniques, which may be followed by, and/or used in conjunction with, reinforced or reinforcement learning techniques. In one aspect, the voice or chatbot may employ the techniques utilized for ChatGPT. The voice bot, chatbot, ChatGPT-based bot, ChatGPT bot, and/or other such generative model may generate audible or verbal output, text or textual output, visual or graphical output, output for use with speakers and/or display screens, augmented reality (AR) or virtual reality (VR) output, and/or other types of output for user and/or other computer or bot consumption.

### Exemplary Computing Environment

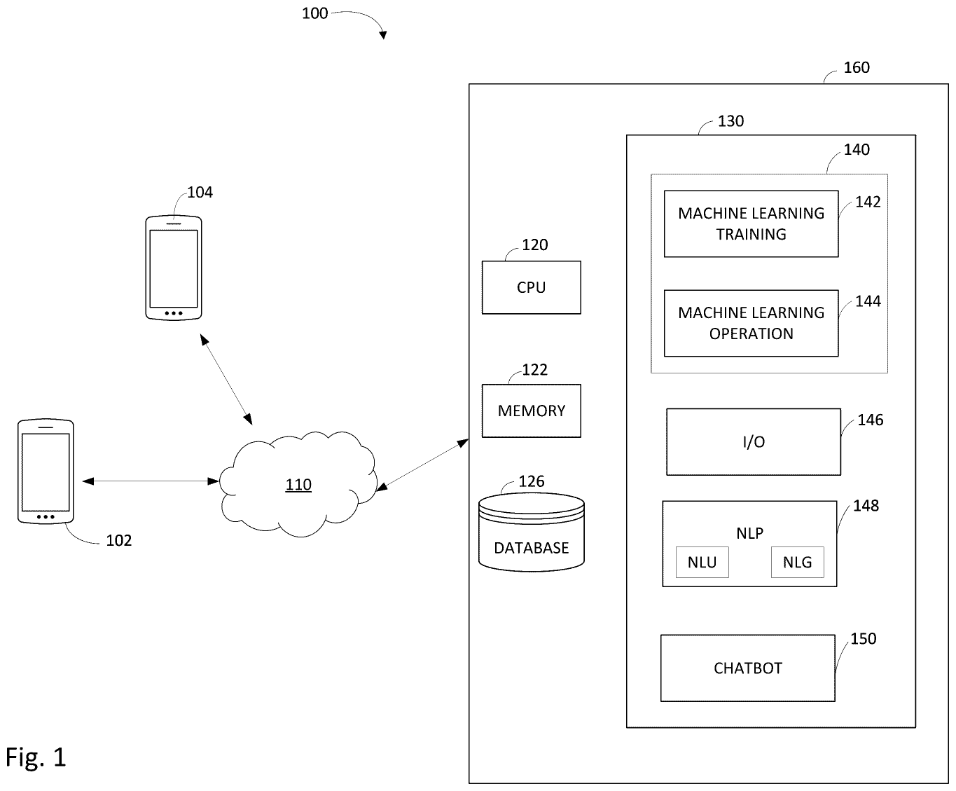

FIG. 1 depicts an exemplary computing environment 100 associated with generating vehicle suggestions based upon driver data. Although FIG. 1 depicts certain entities, components, equipment, and devices, it should be appreciated that additional or alternate entities, components, equipment, and devices are envisioned.

The environment 100 may include a user device 102, a seller communication device 104, and a server 106. The user device 102, seller device 104, and server 106 may be communicatively coupled via an electronic network 110.

As illustrated in FIG. 1, the environment 100 may include a user device 102 associated with a buyer of a vehicle. The buyer may be a driver of the vehicle, or someone purchasing a vehicle on behalf of the driver. The user device 102 may be any suitable device, including one or more computers, mobile devices, wearables, smart watches, smart contact lenses, smart glasses, augmented reality glasses, virtual reality headsets, mixed or extended reality glasses or headsets, and/or other electronic or electrical component. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the computing environment 100 via the network 110.

The environment 100 may also include a seller communication device 104. The seller device 104 may be any suitable device for communication, including one or more computers, mobile devices, wearables, smart watches, smart contact lenses, smart glasses, augmented reality glasses, virtual reality headsets, mixed or extended reality glasses or headsets, telephone, and/or other electronic or electrical component. The seller device 104 may communicate with other components of the computing environment 100 via the network 110.

In one aspect, one or more servers 106 may perform the functionalities as part of a cloud network or may otherwise communicate with other hardware or software components within one or more cloud computing environments to send, retrieve, or otherwise analyze data or information described herein. For instance, in certain aspects of the present techniques, the computing environment 100 may comprise an on-premise computing environment, a multi-cloud computing environment, a public cloud computing environment, a private cloud computing environment, and/or a hybrid cloud computing environment. For example, an entity (e.g., a business) providing a chatbot to generate customized code may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by an enterprise generating the customized code. The public cloud may be partitioned using visualization and multi-tenancy techniques and may include one or more infrastructure-as-a-service (IaaS) and/or platform-as-a-service (PaaS) services.

A network 110 may comprise any suitable network or networks, including a local area network (LAN), wide area network (WAN), Internet, or combination thereof. For example, the network 110 may include a wireless cellular service (e.g., 4G, 5G, 6G, etc.). Generally, the network 110 enables bidirectional communication between the servers 106, a user device 102 and a vehicle 104. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/b/c/g (Wi-Fi), Bluetooth, and/or the like.

The server 106 may include one or more processors 120. The processors 120 may include one or more suitable processors (e.g., central processing units (CPUs) and/or graphics processing units (GPUs)). The processors 120 may be connected to a memory 122 via a computer bus (not depicted) responsible for transmitting electronic data, data packets, or otherwise electronic signals to and from the processors 120 and memory 122 in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 122 via a computer bus to execute an operating system (OS) and/or computing instructions contained therein, and/or to access other services/aspects. For example, the processors 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The database 126 may be a relational database, such as Oracle, DB2, MySQL, a NoSQL based database, such as MongoDB, or another suitable database. The database 126 may store data that is used to train and/or operate one or more ML models, provide augmented reality models/displays, among other things.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 106. For example, libraries may include the TensorFlow based library, the HuggingFace library, the PyTorch library, and/or the scikit-learn Python library.

In one embodiment, the ML module 140 employs supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprising a set of computer-executable instructions implementing ML loading, configuration, initialization and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 102 (for rendering or visualizing) described herein. In one aspect, the servers 106 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, servers 106 or may be indirectly accessible via or attached to the user device 102. According to one aspect, an administrator or operator may access the servers 106 via the user device 102 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the computing modules 130 may include one or more chatbots and/or voice bots 150 which may be programmed to simulate human conversation, interact with users, understand their needs, and recommend an appropriate line of action with minimal and/or no human intervention, among other things. This may include providing the best response of any query that it receives and/or asking follow-up questions.

In some embodiments, the voice bots or chatbots 150 discussed herein may be configured to utilize AI and/or ML techniques. For instance, the voice bot or chatbot 150 may be a ChatGPT chatbot, an InstructGPT bot, a Codex bot, or a Google Bard bot. The voice bot or chatbot 150 may employ supervised or unsupervised ML techniques, which may be followed by, and/or used in conjunction with, reinforced or reinforcement learning techniques. The voice bot or chatbot 150 may employ the techniques utilized for ChatGPT, InstructGPT bot, Codex bot, or Google Bard bot.

Noted above, in some embodiments, a chatbot 150 or other computing device may be configured to implement ML, such that server 106 “learns” to analyze, organize, and/or process data without being explicitly programmed. ML may be implemented through ML methods and algorithms (“ML methods and algorithms”). In one exemplary embodiment, the ML module 140 may be configured to implement ML methods and algorithms.

In one embodiment, the computing environment may generate vehicle suggestions based upon driver data. In one aspect, the user device 102 may transmit driver data to the server 106. The server 106 may cause a such as chatbot 150 may generate vehicle suggestions to the buyer, which may be in audio format, text format, and/or image format. The server 106 may provide the vehicle suggestions to the user device 102 via network 110.

Although the computing environment 100 is shown to include one user device 102, one seller device 104, one server 106, and one network 110, it should be understood that different numbers of user devices 102, seller devices 104, servers 106, and/or networks 110 may be utilized.

The computing environment 100 may include additional, fewer, and/or alternate components, and may be configured to perform additional, fewer, or alternate actions, including components/actions described herein. Although the computing environment 100 is shown in FIG. 1 as including one instance of various components such as user device 102, seller device 104, server 106, network 110, etc., various aspects include the computing environment 100 implementing any suitable number of any of the components shown in FIG. 1 and/or omitting any suitable ones of the components shown in FIG. 1. For instance, information described as being stored at server database 126 may be stored at memory 122, and thus database 126 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 106 and user device 102 may be connected via a direct communication link (not shown in FIG. 1) instead of, or in addition to, via network 110.

### Exemplary Training of the Ml Chatbot Model

An enterprise may be able to use programmable chatbots, such the chatbot 150 (e.g., ChatGPT), to provide tailored, conversational-like customer service relevant to a line of business. The chatbot may be capable of understanding user requests/responses, providing relevant information, etc. Additionally, the chatbot may generate data from user interactions which the enterprise may use to personalize future support and/or improve the chatbot's functionality, e.g., when retraining and/or fine-tuning the chatbot.

The ML chatbot may provide advanced features as compared to a non-ML chatbot, which may include and/or derive functionality from a Large Language Model (LLM). The ML chatbot may be trained on a server, such as server 106, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module, such as the I/O module 146. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances and/or prompts, which may require the ML chatbot to keep track of an entire conversation history as well as the current state of the conversation. The ML chatbot may rely on various techniques to engage in conversations with users, which may include the use of short-term and long-term memory. Short-term memory may temporarily store information (e.g., in the memory 122 of the server 106) that may be required for immediate use and may keep track of the current state of the conversation and/or to understand the user's latest input in order to generate an appropriate response. Long-term memory may include persistent storage of information (e.g., on database 126 of the server 106) which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses.

The system and methods to generate and/or train an ML chatbot model (e.g., via the ML module 140 of the server 106) which may be used by the ML chatbot, may consist of three steps: (1) a Supervised Fine-Tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning Ml Model

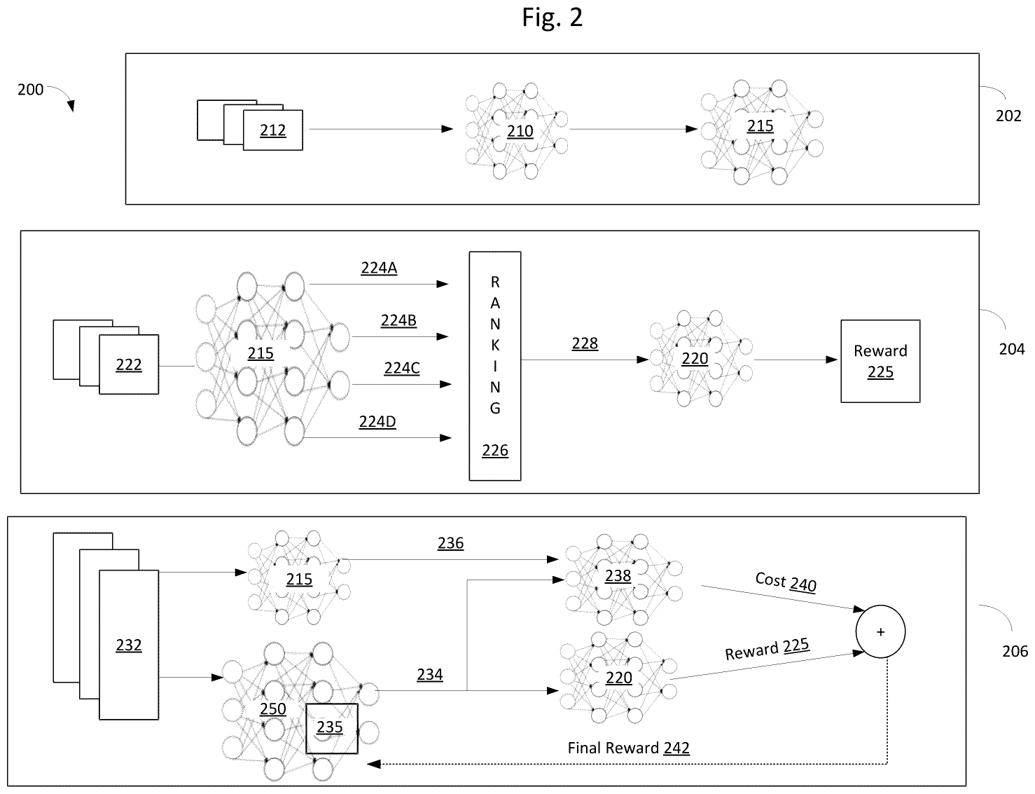

FIG. 2 depicts a combined block and logic diagram 200 for training an ML chatbot model, in which the techniques described herein may be implemented, according to some embodiments. Some of the blocks in FIG. 2 may represent hardware and/or software components, other blocks may represent data structures or memory storing these data structures, registers, or state variables (e.g., data structures for training data 212), and other blocks may represent output data (e.g., 225). Input and/or output signals may be represented by arrows labeled with corresponding signal names and/or other identifiers. The methods and systems may include one or more servers 202, 204, 206, such as the server 106 of FIG. 1.

In one aspect, the server 202 may fine-tune a pretrained language model 210. The pretrained language model 210 may be obtained by the server 202 and be stored in a memory, such as memory 122 and/or database 126. The pretrained language model 210 may be loaded into an ML training module, such as MLTM 142, by the server 202 for retraining/fine-tuning. A supervised training dataset 212 may be used to fine-tune the pretrained language model 210 wherein each data input prompt to the pretrained language model 210 may have a known output response for the pretrained language model 210 to learn from. The supervised training dataset 212 may be stored in a memory of the server 202, e.g., the memory 122 or the database 126. In one aspect, the data labelers may create the supervised training dataset 212 prompts and appropriate responses. The pretrained language model 210 may be fine-tuned using the supervised training dataset 212 resulting in the SFT ML model 215 which may provide appropriate responses to user prompts once trained. The trained SFT ML model 215 may be stored in a memory of the server 202, e.g., memory 122 and/or database 126.

In one aspect, the supervised training dataset 212 may include prompts and responses which may be relevant to generating vehicle suggestions. For example, the trained SFT ML model 215 may include a prompt requesting the buyer for further information on buyer preferences to generate vehicle suggestions. The responses from the trained SFT ML model 215 may include vehicle suggestions. The prompts and response may be via text, audio, multimedia, etc.

### Training the Reward Model

In one aspect, training the ML chatbot model 250 may include the server 204 training a reward model 220 to provide as an output a scaler value/reward 225. The reward model 220 may be required to leverage Reinforcement Learning with Human Feedback (RLHF) in which a model (e.g., ML chatbot model 250) learns to produce outputs which maximize its reward 225, and in doing so may provide responses which are better aligned to user prompts.

Training the reward model 220 may include the server 204 providing a single prompt 222 to the SFT ML model 215 as an input. The input prompt 222 may be provided via an input device (e.g., a keyboard) via the I/O module of the server, such as I/O module 146. The prompt 222 may be previously unknown to the SFT ML model 215, e.g., the labelers may generate new prompt data, the prompt 222 may include testing data stored on database 126, and/or any other suitable prompt data. The SFT ML model 215 may generate multiple, different output responses 224A, 224B, 224C, 224D to the single prompt 222. The server 204 may output the responses 224A, 224B, 224C, 224D via an I/O module (e.g., I/O module 146) to a user interface device, such as a display (e.g., as text responses), a speaker (e.g., as audio/voice responses), and/or any other suitable manner of output of the responses 224A, 224B, 224C, 224D for review by the data labelers.

The data labelers may provide feedback via the server 204 on the responses 224A, 224B, 224C, 224D when ranking 226 them from best to worst based upon the prompt-response pairs. The data labelers may rank 226 the responses 224A, 224B, 224C, 224D by labeling the associated data. The ranked prompt-response pairs 228 may be used to train the reward model 220. In one aspect, the server 204 may load the reward model 220 via the ML module (e.g., the ML module 140) and train the reward model 220 using the ranked response pairs 228 as input. The reward model 220 may provide as an output the scalar reward 225.

In one aspect, the scalar reward 225 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 225 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler via the user device 102 over network 110 to the server 204 running a chatbot application utilizing the SFT ML model 215. The SFT ML model 215 may provide as output responses to the labeler via the user device 102: (i) “the sky is above” 224A; (ii) “the sky includes the atmosphere and may be considered a place between the ground and outer space” 224B; and (iii) “the sky is heavenly” 224C. The data labeler may rank 226, via labeling the prompt-response pairs, prompt-response pair 222/224B as the most preferred answer; prompt-response pair 222/224A as a less preferred answer; and prompt-response 222/224C as the least preferred answer. The labeler may rank 226 the prompt-response pair data in any suitable manner. The ranked prompt-response pairs 228 may be provided to the reward model 220 to generate the scalar reward 225.

While the reward model 220 may provide the scalar reward 225 as an output, the reward model 220 may not generate a response (e.g., text). Rather, the scalar reward 225 may be used by a version of the SFT ML model 215 to generate more accurate responses to prompts, i.e., the SFT model 215 may generate the response such as text to the prompt, and the reward model 220 may receive the response to generate a scalar reward 225 of how well humans perceive it. Reinforcement learning may optimize the SFT model 215 with respect to the reward model 220 which may realize the configured ML chatbot model 250.

### Rlhf to Train the Ml Chatbot Model

In one aspect, the server 206 may train the ML chatbot model 250 (e.g., via the ML module 140) to generate a response 234 to a random, new and/or previously unknown user prompt 232. To generate the response 234, the ML chatbot model 250 may use a policy 235 (e.g., algorithm) which it learns during training of the reward model 220, and in doing so may advance from the SFT model 215 to the ML chatbot model 250. The policy 235 may represent a strategy that the ML chatbot model 250 learns to maximize its reward 225. As discussed herein, based upon prompt-response pairs, a human labeler may continuously provide feedback to assist in determining how well the ML chatbot's 250 responses match expected responses to determine rewards 225. The rewards 225 may feed back into the ML chatbot model 250 to evolve the policy 235. Thus, the policy 235 may adjust the parameters of the ML chatbot model 250 based upon the rewards 225 it receives for generating good responses. The policy 235 may update as the ML chatbot model 250 provides responses 234 to additional prompts 232.

In one aspect, the response 234 of the ML chatbot model 450 using the policy 235 based upon the reward 425 may be compared using a cost function 238 to the SFT ML model 215 (which may not use a policy) response 236 of the same prompt 232. The server 206 may compute a cost 240 based upon the cost function 238 of the responses 234, 236. The cost 240 may reduce the distance between the responses 234, 236, i.e., a statistical distance measuring how one probability distribution is different from a second, in one aspect the response 234 of the ML chatbot model 250 versus the response 236 of the SFT model 215. Using the cost 240 to reduce the distance between the responses 234, 236 may avoid a server over-optimizing the reward model 220 and deviating too drastically from the human-intended/preferred response. Without the cost 240, the ML chatbot model 250 optimizations may result in generating responses 234 which are unreasonable but may still result in the reward model 220 outputting a high reward 225.

In one aspect, the responses 234 of the ML chatbot model 250 using the current policy 235 may be passed by the server 206 to the rewards model 220, which may return the scalar reward or discount 225. The ML chatbot model 250 response 234 may be compared via cost function 238 to the SFT ML model 215 response 236 by the server 206 to compute the cost 240. The server 206 may generate a final reward 242 which may include the scalar reward 425 offset and/or restricted by the cost 240. The final reward or discount 242 may be provided by the server 206 to the ML chatbot model 250 and may update the policy 235, which in turn may improve the functionality of the ML chatbot model 250.

To optimize the ML chatbot 250 over time, RLHF via the human labeler feedback may continue ranking 226 responses of the ML chatbot model 250 versus outputs of earlier/other versions of the SFT ML model 215, i.e., providing positive or negative rewards or adjustments 225. The RLHF may allow the servers (e.g., servers 204, 206) to continue iteratively updating the reward model 220 and/or the policy 235. As a result, the ML chatbot model 250 may be retrained and/or fine-tuned based upon the human feedback via the RLHF process, and throughout continuing conversations may become increasingly efficient.

Although multiple servers 202, 204, 206 are depicted in the exemplary block and logic diagram 200, each providing one of the three steps of the overall ML chatbot model 250 training, fewer and/or additional servers may be utilized and/or may provide the one or more steps of the ML chatbot model 250 training. In one aspect, one server may provide the entire ML chatbot model 250 training.

### Exemplary Ml Model to Generate Vehicle Suggestions

In one embodiment, generating vehicle suggestions based upon driver data may use ML techniques.

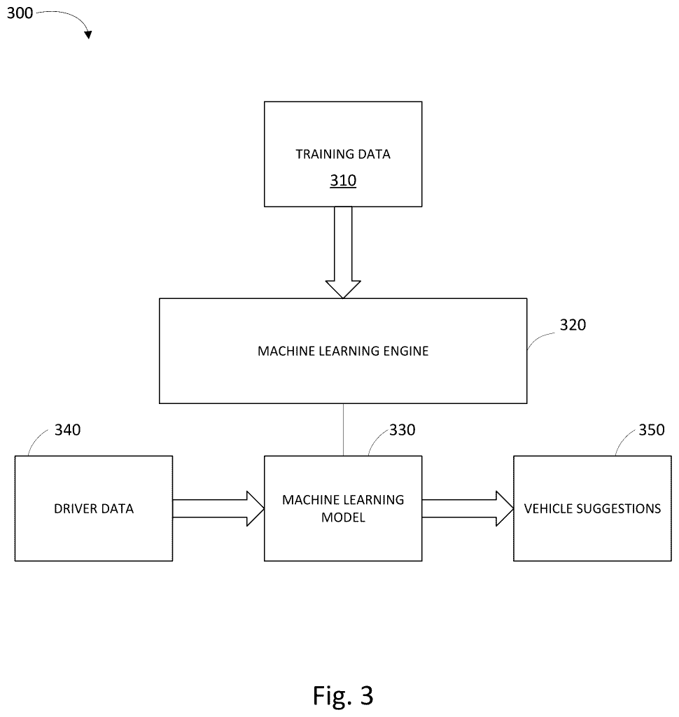

FIG. 3 schematically illustrates how an ML model may generate vehicle suggestions based upon driver data. Some of the blocks in FIG. 3 represent hardware and/or software components (e.g., block 320), other blocks represent data structures or memory storing these data structures, registers, or state variables (e.g., block 310), and other blocks represent output data (e.g., block 350). Input signals are represented by arrows labeled with corresponding signal names.

The ML engine 320 may include one or more hardware and/or software components, such as the MLTM 142 and/or the MLOM 144, to obtain, create, (re) train, operate and/or save one or more ML models 330. To generate the ML model 330, the ML engine 320 may use the training data 310.

As described herein, the server such as server 106 may obtain and/or have available various types of training data 310 (e.g., stored on database 126 of server 106). In one aspect, the training data 310 may labeled to aid in training, retraining and/or fine-tuning the ML model 330. The training data 310 may include vehicle reviews, vehicle specifications, and/or driving behavior data associated with different vehicles. For example, the data may include reviews of a vehicle that state the vehicle has good handling. An ML model 330 may process training data 310 to derive associations between vehicles and vehicle traits. For example, based on the historical driving behavior data, the ML model 330 may detect patterns in the training data which generally indicate a vehicle has good handling. The training data 310 may also include price data associated with vehicles with various features and in various conditions.

While the example training data includes indications of various types of training data 310, this is merely an example for ease of illustration only. The training data 310 may include any suitable data which may associate driver data and vehicles, as well as any other suitable data which may train the ML model 310 to generate vehicle suggestions.

In one aspect, the server may continuously update the training data 310, e.g., based upon obtaining additional data from vehicle reviews, vehicle specifications, driving behavior data associated with different vehicles, and other sources. Subsequently, the ML model 330 may be retrained/fine-tuned based upon the updated training data 310. Accordingly, vehicle suggestions 350 may improve over time.

In one aspect, the ML engine 320 may process and/or analyze the training data 310 (e.g., via MLTM 142) to train the ML model 330 to generate vehicle suggestions 350. The ML model 330 may be trained to generate vehicle suggestions 350 via a regression model, k-nearest neighbor algorithm, support vector regression algorithm, and/or random forest algorithm, although any type of applicable ML model/algorithm may be used, including training using one or more of supervised learning, unsupervised learning, semi-supervised learning, and/or reinforcement learning.

Once trained, the ML model 330 may perform operations on one or more data inputs to produce a desired data output. In one aspect, the ML model 330 may be loaded at runtime (e.g., by MLOM 144) from a database (e.g., database 126 of server 106) to process the driver data 340 data input. Driver data 340 may include vehicle purchase history, driving behavior (e.g., acceleration data, braking data, cornering data, speed data, location data and/or drive duration data), improvements to the driving behavior associated with a driver of a vehicle, and/or any information which may be relevant to generating vehicle suggestions 350. The server, such as server 106, may obtain the driver data 340 and use it as an input to generate vehicle suggestions 350. The server 106 may obtain the driver data 340 via a user device, such as a mobile device associated with a buyer, or other sources such as a connected vehicle, public records, etc.

Once the ML model 330 has generated vehicle suggestions 350, the suggestions 350 may be provided to a user device. For example, the server 106 may provide the suggestions 350 via a mobile app to a mobile device such as user device 102, in an email, via a graphical user interface on an AR device, a website, via a chatbot, and/or in any other suitable manner as further described herein.

### Exemplary Display

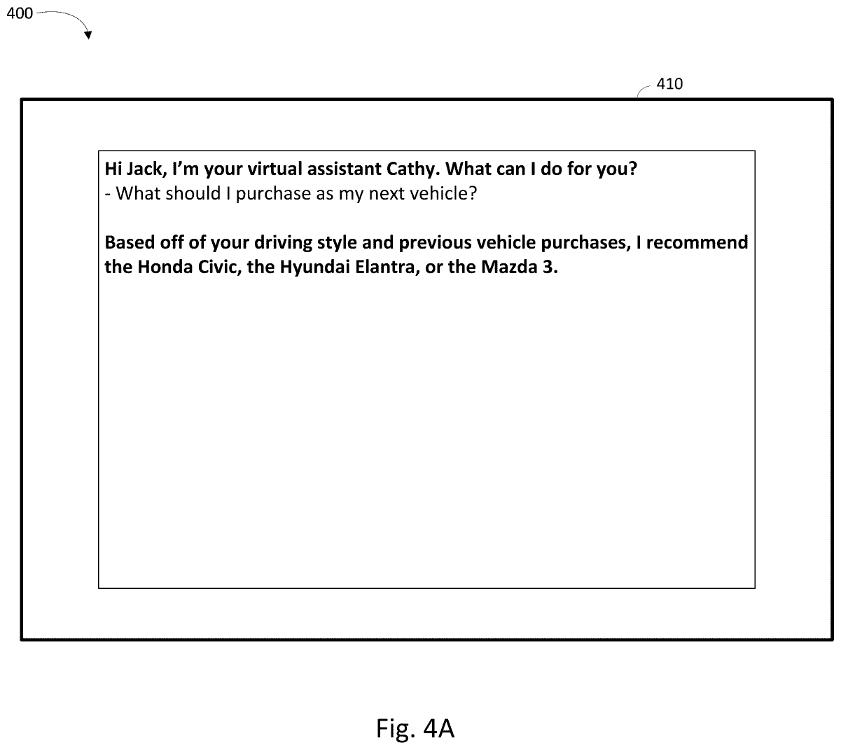

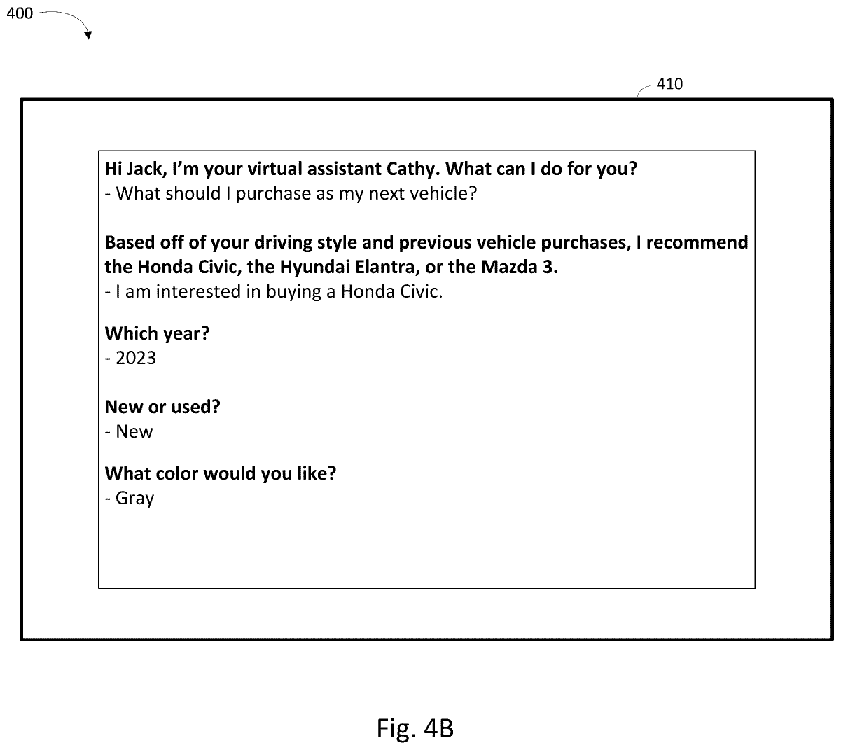

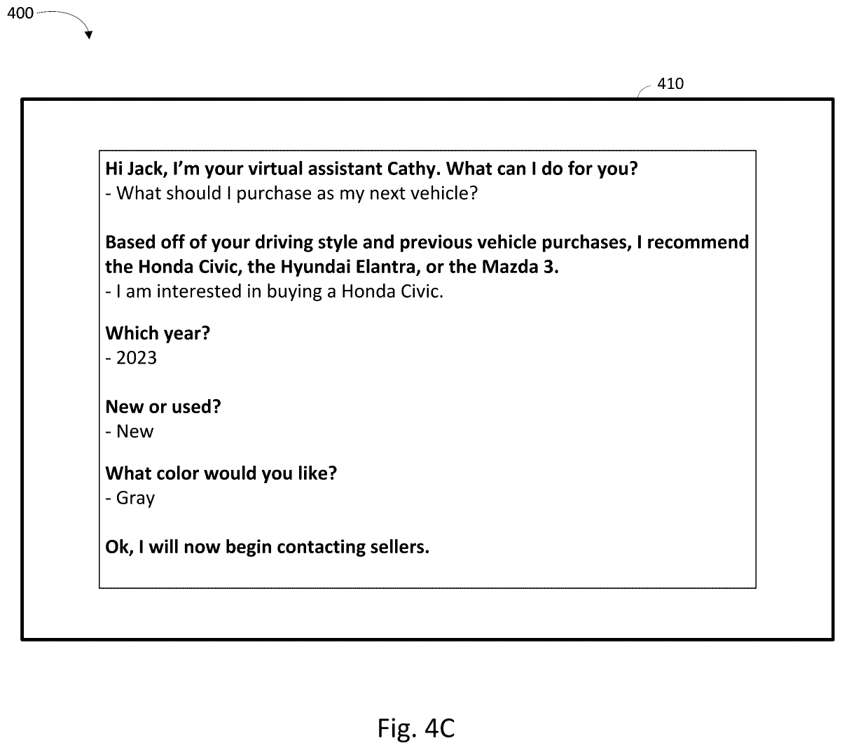

FIGS. 4A-4C depict exemplary displays 400 of a mobile or desktop application (app) employing an ML chatbot (such as the chatbots 150 and 250) to request vehicle suggestions, according to one embodiment. Thus, the displays 400 of FIGS. 4A-4C may depict a single communication session 410 between a user and the ML chatbot. The app may be run on a user device 102 communicating with a server 106 via a network 110.

A user may wish to receive suggestions for vehicles to purchase. In the example of FIG. 4A, a user (“Jack”) may use a mobile app to access a chatbot to request vehicle suggestions. A business enterprise may provide the app and/or ML chatbot to the user. In one example, the only purpose of the app and/or ML chatbot may be to provide vehicle suggestions and facilitate purchase of a vehicle. Accordingly, when the application is running, the ML chatbot may begin the process of suggesting vehicles. In another example, suggesting vehicles may be one of many functions the app and/or ML chatbot provides, and the user may explicitly request the ML chatbot to suggest vehicles e.g., by typing a request, by speaking, by selecting an icon, by selecting a link from a menu, or any other suitable means which allows the ML chatbot to detect the request. In one exemplary display 400, a user may begin the communication session 410 with the ML chatbot. The communication session 410 may include one or more of (i) audio (e.g., a telephone call), (ii) text messages (e.g., short messaging/SMS, multimedia messaging/MMS, iPhone iMessages, etc.), (iii) instant messages (e.g., real-time messaging such as a chat window), (iv) video such as video conferencing, (v) communication using virtual reality, (vi) communication using augmented reality, (vii) blockchain entries, and/or (vii) communication in the metaverse, and/or any other suitable form of communication. The communication session 410 may include instant messaging, interactive icons, and/or an interactive voice session via which the user is able to type and/or speak his or her natural language responses via the smartphone. In FIG. 4, the communication session 410 begins when the ML chatbot (“Cathy”) greets the user and asks for information. The user may respond with a request for vehicle suggestions. The ML chatbot may analyze driving behavior data to generate and provide vehicle suggestions to the user (“the Honda Civic, the Hyundai Elantra, or the Mazda 3”). The ML chatbot may provide this feedback in one or more of text, audio, visual, video, AR, VR, and/or any other suitable format.

The ML chatbot may request additional information regarding the user's preferences on vehicle to better locate a particular vehicle candidate that is available for purchase, as shown in FIG. 4B. For example the ML chatbot may ask one or more follow-up questions for the user's preference on one or more of: price range, a vehicle body style, a number of seats, a fuel source, a vehicle make, a vehicle color, whether the vehicle is new or used, a year range for the vehicle model, a vehicle mileage, a seller inspection report, repair history, maintenance record, number of accidents in which the vehicle has been involved, amount of wear associated with one or more tires associated with the vehicle, distance to a seller of the vehicle, a type of seller, whether the seller allows trading in vehicles, and/or any other relevant questions to find a particular vehicle that best aligns with the user's preferences. Referring to the communication session 410 as illustrated in FIG. 4B, the ML chatbot may ask follow-up questions regarding the model year, whether the car is new or used, and the desired color of the vehicle. Once the chatbot has enough information, the chatbot may search for sellers that have a particular vehicle fitting the user's preferences. Accordingly, referring to the communication session 410 as illustrated in FIG. 4C, the ML chatbot may begin contacting one or more sellers and provide an indication to the user.

### Exemplary Negotiation of Vehicle Purchase

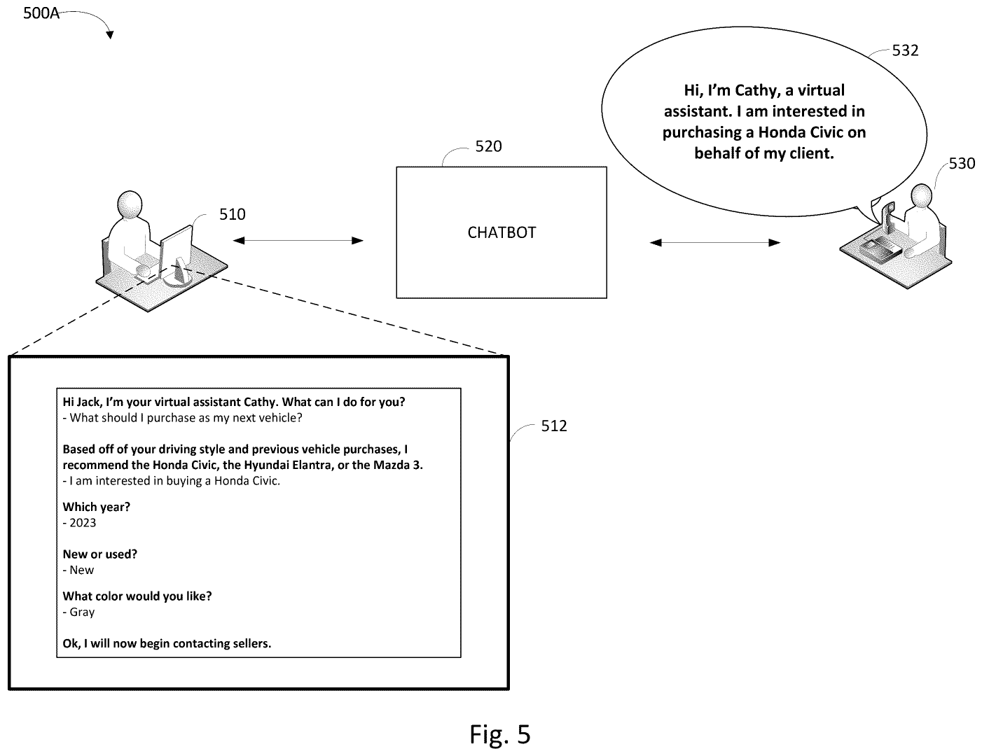

In some embodiments, a buyer may select a particular vehicle from the suggested vehicles presented to the buyer. As shown in FIG. 5, a generative AI such as an AI/ML chatbot and/or voice bot 520 may be used to negotiate for the purchase of the selected vehicle.

In one aspect, the chatbot 520 may search the internet for sellers whose inventory includes or likely includes a particular vehicle candidate matching the buyer's preferences. The chatbot 520 may initiate communications with one or more seller(s) of the particular vehicle 530 to initiate negotiation for the vehicle. A seller of a particular vehicle 530 may be a new car dealership, a used car dealership, private seller, online retailer, etc., and/or a computer system associated therewith. The chatbot 520 may communicate with the seller 530 via (i) audio (e.g., a telephone call), (ii) text messages (e.g., short messaging/SMS, multimedia messaging/MMS, iPhone iMessages, etc.), (iii) instant messages (e.g., real-time messaging such as a chat window), (iv) video such as video conferencing, and/or any other suitable communication means. The chatbot 520 may operate in a conversational manner and provide and collect information without any human intervention.

In one aspect, the chatbot 520 may receive utterances via an audio connection from the seller 530 (e.g., as part of a voice call initiated by the chatbot 150). The chatbot 520 may transcribe the audio utterances into unformatted text. The NLP module 148 may convert the unformatted text into structured input data. The server 150 may store the structured input data in the database 126. The ML module 140 may generate structured output data based upon the input data. The NLP module 148 may convert the structured output data into unformatted text. The chatbot may convert the unformatted text into audio data and output the audio data, e.g., a follow-up question, to the seller 530.

The chatbot may provide information to the seller device 530 such as the desired vehicle, buyer identity, etc. The chatbot may also request relevant information such as the price of the selected vehicle, availability of the selected vehicle, and any other information relevant to the purchase of the vehicle. The server 106 may collect and process the information from the seller 530 via the chatbot 520. The server 106 may analyze and/or process the collected information to interpret, understand and/or extract relevant information within one or more responses from the seller 530.

The chatbot 520 may provide the relevant information to a buyer using user device 510. The chatbot 520 may communicate with the user device 510 via audio, text messages, instant messages, video, email, application notifications, and/or any other suitable communication means. The user device 510 may be one or more of desktop computers, laptops, smartphones, wearables, smart watches, smart contact lenses, smart glasses, augmented reality glasses, virtual reality headsets, and/or any other suitable communication device.

### Exemplary Methods for Generating Vehicle Suggestions

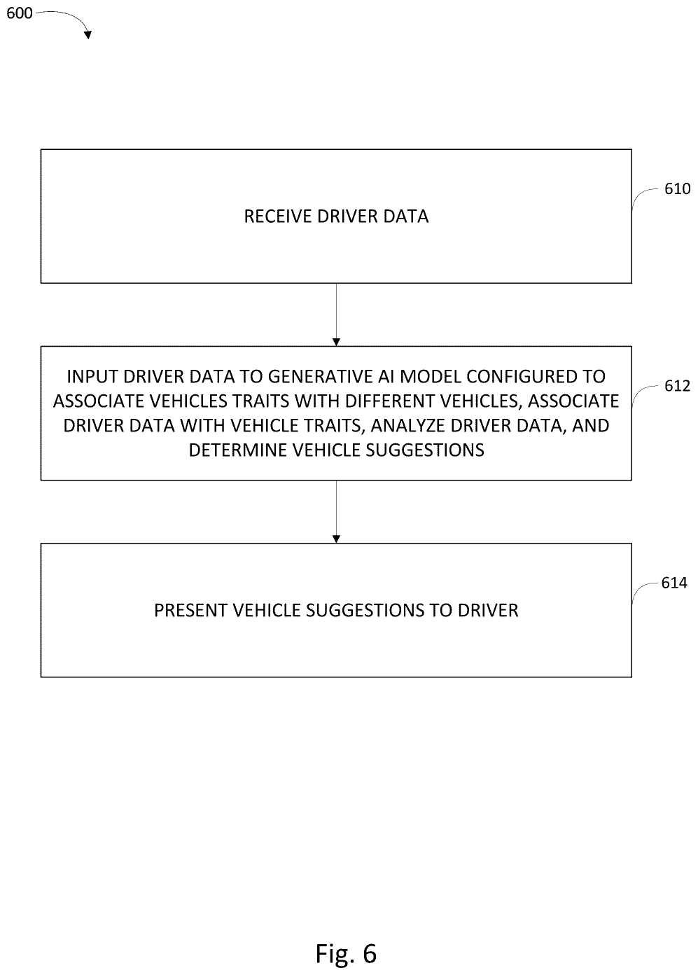

FIG. 6 depicts a flow diagram of an exemplary computer-implemented method 600 for generating vehicle suggestions based upon driver data using a generative AI (e.g., an AI or ML chatbot and/or voice bot). One or more steps of the method 600 may be implemented as a set of instructions stored on a computer-readable memory and executable on one or more processors. The method 600 of FIG. 6 may be implemented via the exemplary computing environment 100 of FIG. 1.

At block 610, the method 600 may include receiving driver data. The server 106 may receive driver data from a user device 102, a connected vehicle, publicly available sources, or any other source. The driver data may include vehicle purchase history associated with the driver, driving behavior associated with the driver, and/or improvements to driving behavior associated with the driver. The driving behavior data may include one or more of acceleration data, braking data, cornering data, speed data, location data, and/or drive duration data.

At block 612, the method 600 may include inputting driving behavior data to a generative AI model, wherein the generative AI model is configured to (1) associate vehicle traits with different vehicles, (2) associate driver data with vehicle traits, (3) analyze driver data, and/or (4) determine vehicle suggestions. The generative AI model may be trained on vehicle reviews and/or vehicle specifications. The generative AI model may be trained using supervised learning, unsupervised learning, or reinforcement learning techniques.

At block 614, the method 600 may include presenting the vehicle suggestions to the driver. The vehicle suggestions may be presented to the driver in text, images, audio, video, augmented reality and/or virtual reality. Additionally or alternatively, the output and/or vehicle suggestions may be text, textual, visual, or graphical output and/or vehicle suggestions that are presented on a display, screen or other medium, and/or verbal or audible output and/or vehicle suggestions presented via a voice bot, chatbot, or other means.

In some embodiments, the method may further include receiving additional parameters from the buyer. Additional parameters may include a price range, a vehicle body style, a number of seats, a fuel source, a vehicle make, a vehicle color, whether a vehicle is new or used, a year range for the vehicle model, a vehicle mileage, a seller inspection report, a repair history associated with the vehicle, a maintenance record associated with the vehicle, a number of accidents in which the vehicle has been involved, an amount of wear associated with one or more tires associated with the vehicle, a distance to a seller of the vehicle, a type of seller, whether the seller allows trading in a vehicle, and/or any other relevant parameters. The method may include inputting the additional parameters to the generative AI to generate vehicle suggestions more suited to the buyer's preferences.

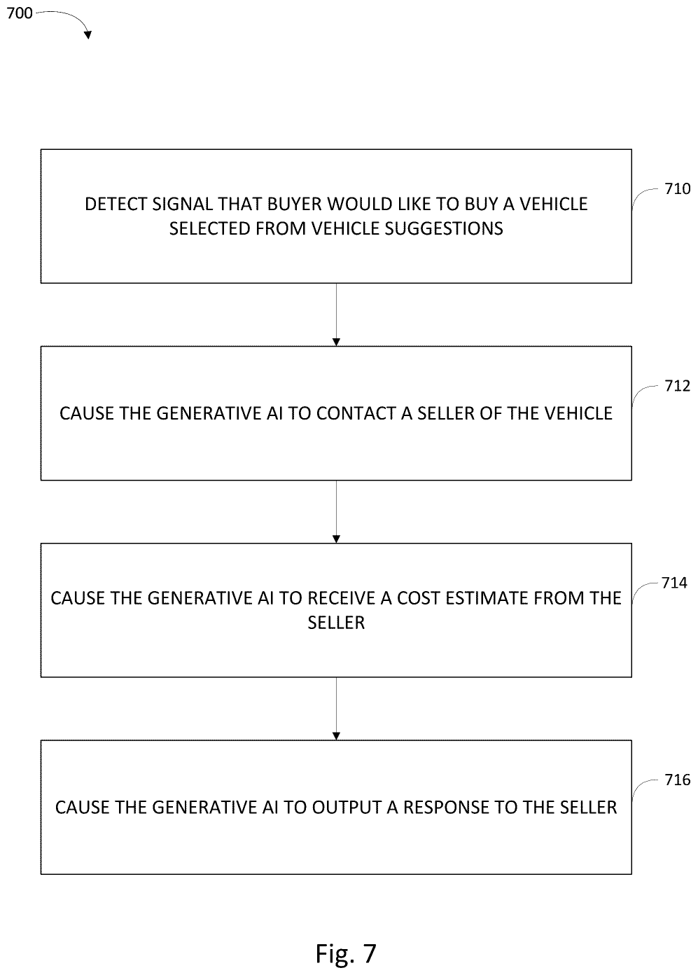

In some embodiments, the method 600 may further include a method 700 negotiating for the purchase of a vehicle, as shown in FIG. 7. At block 710, the generative AI model may detect a signal that a buyer would like to buy a particular vehicle selected from the vehicle suggestions. At block 712, the generative AI model may contact one or more sellers of the vehicle to inquire into purchasing the selected vehicle. The generative AI model may contact the one or more sellers over a phone call by converting a text output into a voice/audio output. At block 714, generative AI model may receive a cost estimate of the vehicle from the one or more sellers. The generative AI model may convert voice/audio input of the cost estimate from the one or more sellers into a text input. At block 716, the generative AI may output a response to the one or more sellers. The generative AI may have been further trained on price data to assess whether a contacted seller's quoted price is fair for the vehicle. The generative AI model may convert a text output of the response into a voice/audio output.

Additionally or alternatively, the output may be text, textual, visual, or graphical output and/or vehicle suggestions that are presented on a display, screen or other medium, and/or verbal or audible output presented via a voice bot, chatbot, or other means.

### ADDITIONAL CONSIDERATIONS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed:

1. A computer-implemented method for providing vehicle suggestions to a buyer, the method comprising:
detecting, by one or more processors, a signal that the buyer is interested in purchasing a vehicle,
obtaining, by the one or more processors, driver data associated with a driver;
inputting, by the one or more processors, the driver data associated with the driver into a generative artificial intelligence (AI) model to generate vehicle suggestions for the driver, wherein the generative AI model is trained on vehicle data to identify vehicle traits and is configured to:
associate vehicle traits with different vehicles,
associate driver data with vehicle traits,
analyze data associated with the driver to identify vehicle traits associated with a driver,
determine, based upon the desired vehicle traits associated with the driver, vehicle suggestions, and
generate an output including vehicle suggestions for the driver; and
presenting, by the one or more processors, the vehicle suggestions to the buyer.

2. The computer-implemented method of claim 1, wherein the driver data associated with the driver includes at least one of: (i) vehicle purchase history associated with the driver; (ii) driving behavior associated with the driver and/or (iii) improvements to the driving behavior associated with the driver.

3. The computer-implemented method of claim 2, wherein the driving behavior data includes one or more of: (i) acceleration data; (ii) braking data; (iii) cornering data; (iv) speed data; (v) location data and/or (vi) drive duration data.

4. The computer-implemented method of claim 1, wherein inputting the driver data into the generative AI model comprises:
receiving, by the one or more processors, additional parameters specified by the buyer; and
inputting, by the one or more processors, the additional parameters to the generative AI.

5. The computer-implemented method of claim 4, wherein the additional parameters include one or more of the following: (i) a price range; (ii) a vehicle body style; (iii) a number of seats; (iv) a fuel source; (v) a vehicle make; (vi) a vehicle color; (vii) whether a vehicle is new or used; (viii) a year range for a vehicle model; (ix) a vehicle mileage; (x) a seller inspection report; (xi) a repair history associated with a vehicle; (xii) a maintenance record associated with the vehicle; (xiii) a number of accidents in which the vehicle has been involved; (xiv) an amount of wear associated with one or more tires associated with the vehicle; (xiv) a distance to a seller of the vehicle; (xv) a type of seller; and/or (xvi) whether the seller allows trading in the vehicle.

6. The computer-implemented method of claim 1, wherein the vehicle data includes one or more of the following: (i) vehicle reviews; and/or (ii) vehicle specifications.

7. The computer-implemented method of claim 1, wherein the output of suggested vehicles is in the form of one or more of the following: (i) text; (ii) images; (iii) audio; (iv) video; (v) augmented reality (AR) and/or (vi) virtual reality (VR).

8. The computer-implemented method of claim 1, further comprising:
detecting a signal that the buyer would like to buy a particular vehicle selected from the vehicle suggestions to cause the generative AI model to perform one or more of:
contacting one or more sellers of the vehicle to inquire into purchase of the vehicle,
receiving a cost estimate from the one or more sellers, and/or
outputting a response to the one or more sellers.

9. The computer-implemented method of claim 8, wherein the generative AI model is further trained with price data associated with vehicles.

10. The computer-implemented method of claim 1, further comprising:
detecting a signal that the buyer would like to buy a particular vehicle selected from the vehicle suggestions;
inputting the signal that the buyer would like to buy the particular vehicle into the generative AI model, wherein inputting the signal causes the generative AI to:
contact one or more sellers of the vehicle via telephone by converting a first text output into a first voice output,
receive a cost estimate from the one or more sellers via telephone by converting a voice input into a text input, and
output a response to the one or more sellers via telephone by converting a second text output into a second voice output.

11. The computer-implemented method of claim 1, wherein the generative AI model includes at least one of: (i) an AI or machine learning (ML) chatbot and/or (ii) an AI or ML voice bot.

12. A computer system for providing vehicle suggestions to a buyer, the computer system comprising:
one or more processors;
one or more non-transitory memories storing processor-executable instructions that, when executed by the one or more processors, cause the system to:
detect that a buyer is interested in buying a vehicle,
obtain driver data associated with a driver,
input the driver data associated with the driver to a generative AI model to generate vehicle suggestions for the buyer, wherein the generative AI model is trained on vehicle data to identify vehicle traits and is configured to
associate vehicle traits with different vehicles,
analyze data associated with the driver to identify vehicle traits associated with a driver,
determine, based upon the desired vehicle traits associated with the driver, vehicle suggestions, and
generate an output including vehicle suggestions for the driver; and
present the vehicle suggestions to the buyer.

13. The computer system of claim 12, wherein the driver data associated with the driver includes at least one of (i) vehicle purchase history associated with the driver; (ii) driving behavior associated with the driver and/or (iii) improvements to the driving behavior associated with the driver.

14. The computer system of claim 12, wherein to input the driver data into the generative AI model, the instructions, when executed by the one or more processors, cause the system to:
receive additional parameters specified by the buyer; and
input the additional parameters to the generative AI model.

15. The computer system of claim 12, wherein the instructions, when executed by the one or more processors, further causes the system to:
detect a signal that the buyer would like to buy a vehicle selected from the vehicle suggestions to cause the generative AI model to perform one or more of:
contacting one or more sellers of the vehicle to inquire into purchase of the vehicle,
receiving a cost estimate from the one or more sellers, and/or
outputting a response to the one or more sellers.

16. The computer system of claim 12, wherein the instructions, when executed by the one or more processors, further causes the system to:
detect a signal that the buyer would like to buy a particular vehicle selected from the vehicle suggestions,
input the signal that the buyer would like to buy the particular vehicle into the generative AI model, wherein inputting the signal causes the generative AI model to:
contact one or more sellers of the vehicle via telephone by converting a first text output into a first voice output,
receive a cost estimate from the one or more sellers via telephone by converting a voice input into a text input,
output a response to the one or more sellers via telephone by converting a second text output into a second voice output.

17. A non-transitory computer-readable medium storing processor-executable instructions for providing vehicle suggestions to a buyer that, when executed by one or more processors, cause the one or more processors to:
detect a signal that a buyer is interested in purchasing a vehicle,
obtain driver data associated with a driver,
input the driver data associated with the driver to a generative AI model to generate vehicle suggestions for the buyer, wherein the generative AI model is trained on vehicle data to identify vehicle traits and is configured to:
associate vehicle traits with different vehicles,
analyze data associated with the driver to identify vehicle traits associated with a driver,
determine, based upon the desired vehicle traits associated with the driver, vehicle suggestions, and
generate an output including vehicle suggestions for the buyer; and
present the vehicle suggestions to the buyer.

18. The computer-implemented method of claim 17, wherein the driver data associated with the driver includes at least one of: (i) vehicle purchase history associated with the driver; (ii) driving behavior associated with the driver; and/or (iii) improvements to the driving behavior associated with the driver.

19. The non-transitory computer-readable medium of claim 17, wherein the instructions, when executed on one or more processors, further cause the one or more processors to:
detect a signal that the buyer would like to buy a vehicle selected from the vehicle suggestions to cause the generative AI model to perform one or more of:
contact one or more sellers of the vehicle to inquire into purchase of the vehicle,
receive a cost estimate from the one or more sellers, and/or
output a response to the one or more sellers.

20. The non-transitory computer-readable medium of claim 17, wherein the instructions, when executed on one or more processors, further cause the one or more processors to:
detect a signal that the buyer would like to buy a particular vehicle selected from the vehicle suggestions,
input the signal that the buyer would like to buy the particular vehicle into the generative AI model, wherein inputting the signal causes the generative AI to:
contact one or more sellers of the vehicle via telephone by converting a first text output into a first voice output,
receive a cost estimate from the one or more sellers via telephone by converting a voice input into a text input, and
output a response to the one or more sellers via telephone by converting a second text output into a second voice output.
